(19) United States
(12) Patent Application Publication
(10) Pub. No.: US 2011/0050631 A1
(43) Pub. Date: Mar. 3, 2011

(54) TOUCH SENSOR

(75) Inventors: Oh Jin KWON, Daejeon (KR); II Hyun Yun, Daejeon (KR); Kyung Dae Kim, Daejeon (KR); Jae Min Lee, Pohang-si (KR); Hyung Cheol Shin, Daejeon (KR)

(73) Assignee: SAIN InfoCom., Daejeon (KR)

(21) Appl. No.: 12/861,223

(22) Filed: Aug. 23, 2010

(30) Foreign Application Priority Data
Aug. 25, 2009 (KR) 10-2009-0078581

(51) Int. Cl. G06F 3/045

(52) U.S. Cl. 345/174

(57) ABSTRACT

A touch sensor includes a plurality of operation patterns arranged in a first axis direction and supplied with a voltage, a dielectric material layer formed over the plurality of operation patterns, and a plurality of sense patterns formed over the dielectric material layer and arranged in a second axis direction to cross the first axis direction. At least one of the plurality of sense patterns has a parallel structure in which the sense pattern is separated into two or more lines, and the separated sense patterns are recombined once or more. A touch screen having a low resistance value can be obtained.

### CROSS-REFERENCE TO RELATED APPLICATION

This application claims priority to and the benefit of Korean Patent Application No. 10-2009-0078581 filed in the Korean Intellectual Property Office on Aug. 25, 2009, the entire contents of which are incorporated herein by reference.

### BACKGROUND OF THE INVENTION

The present invention relates to a touch sensor. More particularly, the present invention relates to a touch sensor and a touch screen of a capacitive type, having a low resistance value.

Display devices, such as a liquid crystal display and an organic light emitting display, portable transmission devices, and other information processing devices, are configured to perform their functions using a variety of input devices. Touch sensors (as used herein, the terms “touch sensor” and “touch screen” are used interchangeably) have recently been widely used as the input devices.

In the touch screen device, a user can write letters or draw a picture by using a finger, a touch pen, or a stylus on a screen, and can perform a desired command by executing an icon. The touch screen device can determine whether a user's finger or a touch pen has contacted the screen and the position of the screen where the user's finger or the touch pen has contacted.

Such a touch screen device can be largely divided into a resistive type and a capacitive type according to a method of sensing a touch.

The resistive touch screen has a structure in which a resistive material is coated on a glass or transparent plastic plate and a polyester film is formed on the resistive material. In this structure, insulating poles are installed at regular intervals in order to prevent two faces from coming into contact with each other. When the screen is touched, resistance is changed and thus voltage is changed. A contact point is sensed by detecting the change in the voltage. One disadvantage of the resistive touch screen is that it has difficulty sensing a contact point when pressure is weak.

The capacitive touch screen is configured to generate a capacity by coating with a transparent conductive metal within the screen and measure a variation of capacitance. The capacitive touch screen uses a controller to sense a contact point by analyzing a high frequency waveform that varies when an object such a finger touches the screen. The capacitive type is largely classified into a self-capacitive method and a mutual-capacitive method. In the self-capacitive method, a capacitance between a contacting object and a transparent conductive metal is measured. In the mutual-capacitive method, sense patterns and operation patterns provides capacitance, which is varied with contact of an object. In accordance with the self-capacitive method, a touch screen can be constructed with a low cost, but the sense patterns are influenced by noise and electromagnetic interference (EMI) generated from a display device to which the touch screen is attached. The mutual-capacitive method has a more complicated structure than the self-capacitive method, but is excellent in performance of a touch screen because it is less influenced by noise and EMI generated from a display device.

Meanwhile, there is a method of increasing the size of a touch panel in order to increase the sensitivity of the capacitive touch screen and check whether an object has approached at a long distance. If the size of the touch panel is larger than that of the object, the touch panel can detect the object, but may have difficulty in accurately determining what part of the touch panel the object has been placed.

The above information disclosed in this Background section is only for enhancement of understanding of the background of the invention and therefore it may contain information that may not be prior art.

### SUMMARY OF THE INVENTION

The present invention has been made in an effort to provide a touch sensor and a touch screen having an advantage of low resistance.

The present invention has been made in an effort to provide a touch sensor and a touch screen having an advantage of excellent touch sensitivity by increasing the density of sense patterns.

An exemplary embodiment of the present invention provides a capacitive touch sensor in which a plurality of operation patterns and a plurality of sense patterns are arranged, wherein at least one of the plurality of sense patterns that can be independently operated has a parallel structure in which the sense pattern is separated into two or more lines and the separated sense patterns are recombined once or more.

The plurality of operation patterns and the plurality of sense patterns can be arranged in different layers.

At least one of the plurality of operation patterns can have a rectangular structure.

At least one of the plurality of sense patterns can have a parallel structure in which the separation of the sense pattern into two or more lines and the recombination of the separated sense patterns are repeated twice or more.

The width of the operation pattern can be wider than the line width of the sense pattern.

At least one of the plurality of operation patterns can have a parallel structure in which the operation pattern is separated into two or more lines and the separated operation patterns are recombined once or more.

Another exemplary embodiment of the present invention provides a touch screen including a plurality of operation patterns arranged in a first axis direction and supplied with a voltage, a dielectric material layer formed over the plurality of operation patterns, and a plurality of sense patterns formed over the dielectric material layer and arranged in a second axis direction to cross the first axis direction. At least one of the plurality of sense patterns has a parallel structure in which the sense pattern is separated into two or more lines and the separated sense patterns are recombined once or more.

The touch screen can further include a protection window formed over the plurality of sense patterns.

The operation patterns and the sense patterns can be made of a transparent conductive material.

At least one of the plurality of operation patterns can have a rectangular structure.

At least one of the plurality of sense patterns can have a parallel structure in which the separation of the sense pattern into two or more lines and the recombination of the separated sense patterns is repeated twice or more.

The sense pattern can be symmetrically separated into the two or more lines and the separated sense patterns can be symmetrically recombined.

At least one of the plurality of operation patterns can have a parallel structure in which the operation pattern is separated into two or more lines and the separated operation patterns are recombined once or more.

### BRIEF DESCRIPTION OF THE DRAWINGS

FIG. 1 shows an example of the cross-section of a typical touch screen;

FIG. 2a illustrates the structure of a touch screen according to an exemplary embodiment of the present invention;

FIG. 2b illustrates sense patterns included in the touch screen of FIG. 2a;

FIG. 2c illustrates operation patterns included in the touch screen of FIG. 2a;

FIG. 3a is a cross-sectional view of a touch screen 300a in which the sense pattern is separated into two or more lines in FIG. 2;

FIG. 3b is a cross-sectional view of a touch screen 300b in which the sense pattern is merged and formed of a single line;

FIGS. 4a to 4d show sense patterns having various forms according to an exemplary embodiment of the present invention; and

FIGS. 5a and 5b show sense patterns having various forms according to another exemplary embodiment of the present invention.

### DETAILED DESCRIPTION OF THE EMBODIMENTS

Hereinafter, the present invention will be described more fully with reference to the accompanying drawings, in which exemplary embodiments of the invention are described. As those skilled in the art would realize, the described embodiments may be modified in various ways without departing from the spirit or scope of the present invention.

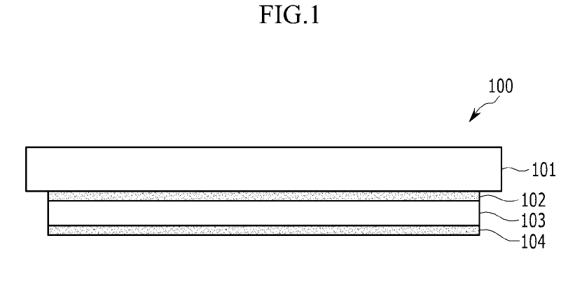

FIG. 1 shows an example of the cross-section of a typical touch screen. A description of the operation circuit and the additional elements of the touch screen is omitted.

Referring to FIG. 1, a touch screen 100 includes a protection window 101, sense patterns 102, a dielectric material layer 103, and operation patterns 104. The sense patterns 102, the dielectric material layer 103, and the operation patterns 104 may be commonly called an electrode layer.

The protection window 101 is placed at the highest layer of the touch screen and is configured to protect the electrode layer. One surface of the protection window functions as a touch surface of the touch screen, and the opposing surface thereof faces the electrode layer. The protection window is configured to protect the electrode layer from environmental dangers, and also serves as a dielectric material between a touching object (e.g., a user's finger) and the electrode layer.

The sense patterns 102 and the operation patterns 104 can be made of a conductive material. The sense patterns 102 and the operation patterns 104 are connected to the operation circuit and the additional elements of the touch screen, and are configured to determine whether the touch screen has been touched. In order to operate the touch screen, a voltage is supplied to the operation patterns 104. Accordingly, touch screens having various functions can be constructed according to the patterns of the sense patterns 102 and the operation patterns 104. The dielectric material layer 103 is disposed between the sense patterns 102 and the operation patterns 104. The dielectric material layer 103, the sense patterns 102, and the operation patterns 104 define a capacitor.

In an example, the sense patterns and the operation patterns can be formed of thin lines having the same width. Here, since the sense patterns do not cover a wide area, there is a problem in that many of the sense patterns and the operation patterns are required.

In another example, the sense patterns and the operation patterns can be constructed in such a way as to be wound in parallel. In this case, there is an advantage in that sensitivity is increased, but there is a disadvantage in that resistance is increased because the length of the patterns is increased.

In yet another example, the sense patterns and the operation patterns can have a diamond structure. Here, the operation patterns do not cover the entire touch screen area. When the touch screen is operated, the remaining operation patterns other than one operation pattern are grounded. If the grounded operation pattern covers only half the touch screen, there is a problem in that the sense patterns are influenced by noise, EMI, etc. generated from a display device.

Accordingly, there is a need for a touch screen structure that can solve one or more of the above problems.

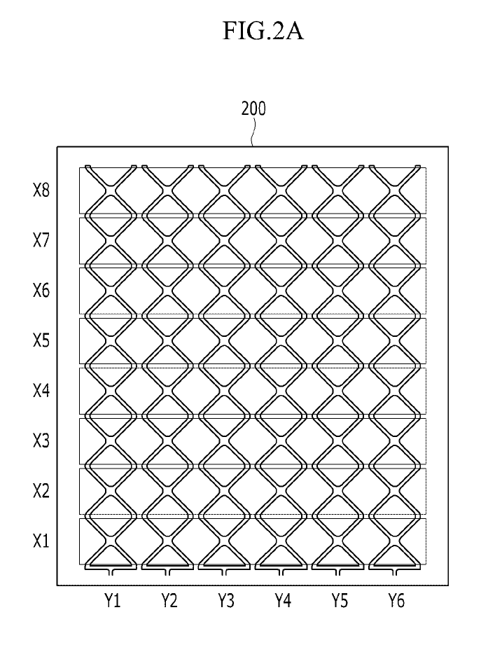

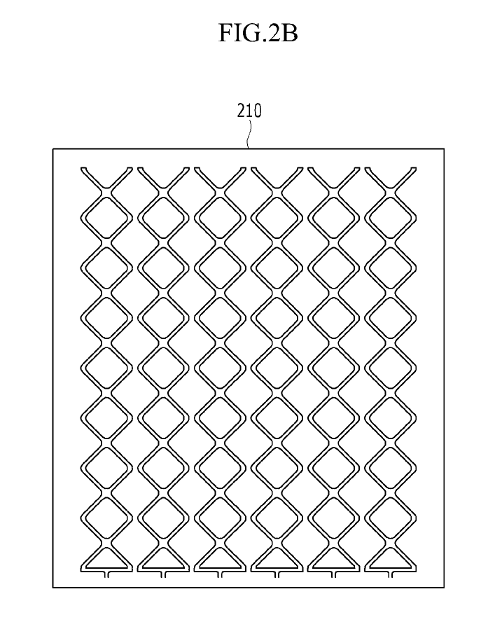

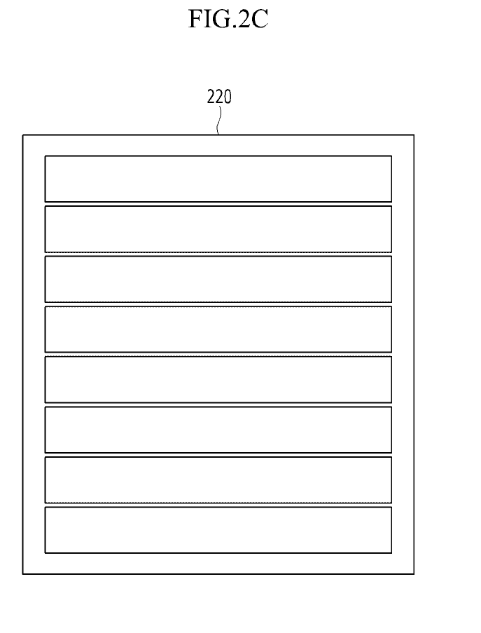

FIG. 2a is a diagram showing the structure of a touch screen according to an exemplary embodiment of the present invention, FIG. 2b is a diagram showing the structure of sense patterns included in the touch screen of FIG. 2a, and FIG. 2c is a diagram showing the structure of operation patterns included in the touch screen of FIG. 2a. Hereinafter, for illustrative convenience, the protection window and the dielectric material layer are not shown.

Referring to FIGS. 2a to 2c, a touch screen 200 includes a plurality of sense patterns (Y1, Y2, . . . , Y6) 210 and a plurality of operation patterns (X1, X2, . . . , X8) 220. The plurality of sense patterns 210 and the plurality of operation patterns 220 are arranged in different layers. For example, the plurality of sense patterns 210 can be arranged over the plurality of operation patterns 220. The plurality of operation patterns can be arranged in a first direction, and the plurality of sense patterns can be arranged in a second direction to cross the first direction. In an implementation, the first direction and the second direction are orthogonal to each other. In another implementation, the first direction and the second direction define an acute angle. In yet another implementation, the first direction and the second direction define an obtuse angle.

At least one of the plurality of operation patterns X1, X2, . . . , X8 has a rectangular structure. For example, each of the plurality of operation patterns X1, X2, . . . , X8 can have a wide rectangular structure and the plurality of operation patterns X1, X2, . . . , X8 cover most of the area of the touch screen. Accordingly, during the time for which the touch screen is operated, if the remaining operation patterns other than a selected operation pattern are grounded, the influence of noise, EMI, etc., generated from a display device, on the sense patterns can be minimized. In an implementation, the width of the operation pattern is wider than the width of the sense pattern.

At least one of the plurality of sense patterns Y1, Y2, . . . , Y6 can have a parallel structure in which the sense pattern is separated into two or more lines and the separated sense patterns are recombined once or more. At least one of the plurality of sense patterns Y1, Y2, . . . , Y6 can have a parallel structure in which the separation of the sense pattern into two or more lines and the recombination of the separated sense patterns are repeated twice or more. In general, the sense pattern is formed of a thin line made of a conductive material. Accordingly, the sense pattern has a high resistance value, and there is no significant problem in power consumption according to a resistance value. If the sense patterns are configured to have a parallel structure in which the sense pattern is separated into two or more lines and the separated sense patterns cross each other, the resistance component of the sense patterns can be reduced.

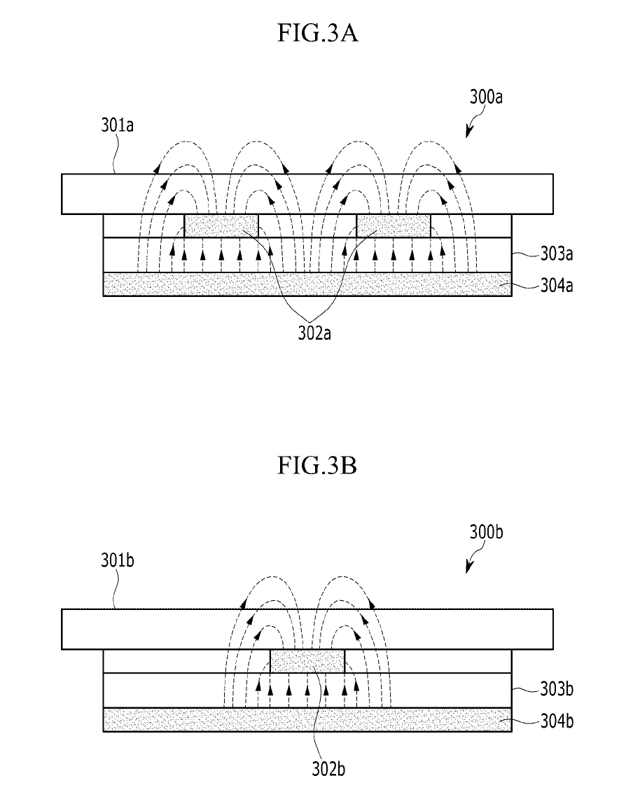

FIG. 3a is a cross-sectional view of a touch screen 300a showing a first region in which the lines of the sense pattern are separated from each other, and FIG. 3b is a cross-sectional view of a touch screen 300b showing a second region in which the lines of the sense pattern are merged together.

Referring to FIGS. 3a and 3b, when voltage is applied to the operation pattern 304a, 304b, an electric field is generated. Meanwhile, when an object touches the touch screen, an electric field at a portion of the protection window 301a, 301b from which the electric field extends above the sense pattern 302a, 302b (i.e., a portion where the sense pattern 302a, 302b does not overlap the operation pattern 304a, 304b) is reduced. Accordingly, the amount of electrical charges of the dielectric material layer 303a, 303b is reduced, and whether an object has touched the touch screen can be determined based on a change in the amount of electrical charges in the dielectric material layer 303a, 303b.

When comparing FIGS. 3a and 3b, the density of the sense patterns 302a of FIG. 3a is higher than the density of the sense patterns 302b of FIG. 3b for the same area of the operation patterns 304a and 304b. Consequently, the touch screen 300a in which at least one of the sense patterns is separated into two or more lines as in FIG. 3a has much better sensitivity. Accordingly, in the case in which an object moves from one sense pattern to an adjacent sense pattern, an excellent sense effect can be obtained.

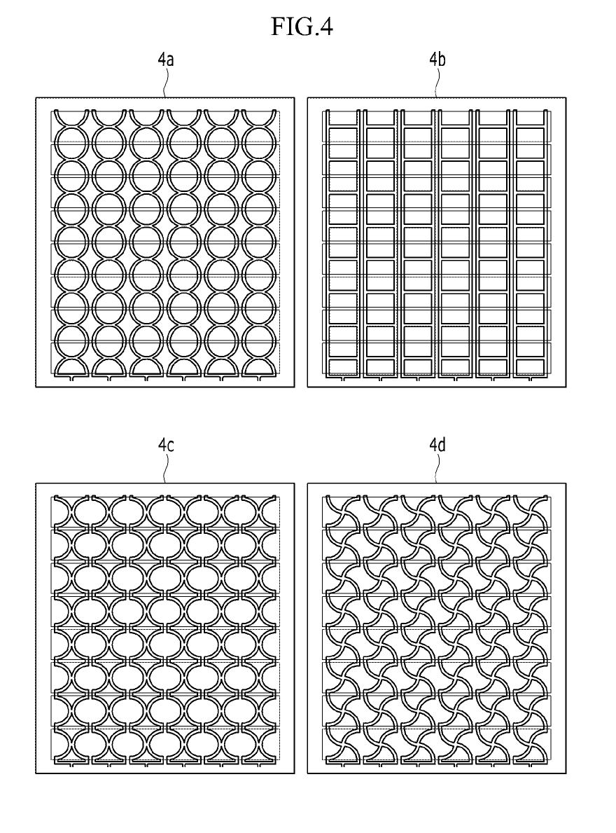

FIGS. 4a to 4d show sense patterns having various forms according to an exemplary embodiment of the present invention.

Referring to FIGS. 4a to 4d, a structure in which a sense pattern is formed of two lines (or strings). The lines are separated at one point (a first region) and then are merged together at another point (a second region). The first and the second regions are alternatively repeated. In addition, a variety of exemplary variations are available.

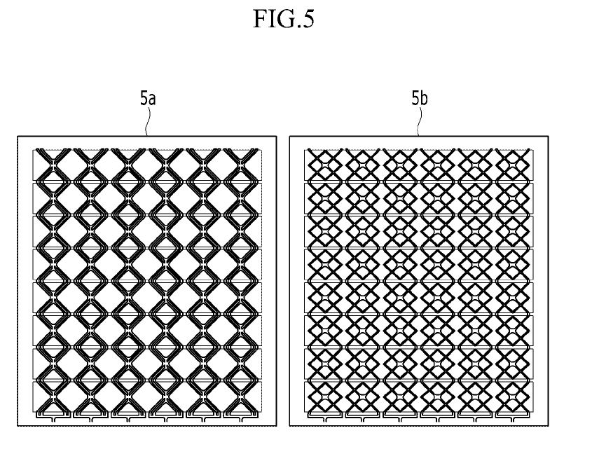

FIGS. 5a and 5b show sense patterns having various forms according to another exemplary embodiment of the present invention.

FIG. 5a is a modification of the sense patterns shown in FIG. 2. In FIG. 5a, one sense pattern is formed of four lines, and the sense patterns are separated from each other and cross each other in two pairs. Accordingly, the transparency of the touch screen can be increased.

FIG. 5b is a modification of the sense patterns shown in FIG. 2. In FIG. 5b, a pattern of a quadrangular form is added at a point where two lines constituting one sense pattern cross each other. Accordingly, the density of the sense patterns in the touch screen can be increased, and the resolution of the touch screen can be enhanced. In the case in which the touch screen is applied to a large-sized screen, sensitivity can be increased by using the sense patterns having a complicated structure. In addition to the above patterns, various exemplary variations can exist.

In the present specification, the sense patterns are illustrated to have the parallel structure in which the sense pattern is separated into two or more lines and the separated sense patterns are recombined once or more, but they are not limited thereto. For example, the operation patterns can be configured to have a parallel structure in which at least one of the operation patterns is separated into two or more lines and the separated operation patterns are recombined once or more.

The sense patterns and the operation patterns are arranged in different layers or on the same layer according to implementation.

The touch sensor and the touch screen, having low resistance, excellent touch sensitivity resulting from a high density of the sense patterns, and stable touch sensitivity resulting from shielded noise or EMI, can be obtained.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A capacitive touch sensor comprising:
a plurality of operation patterns; and
a plurality of sense pattern, each sense pattern including a plurality of lines intersecting at one or more points, wherein at least one of the plurality of sense patterns is configured to independently operated.

2. The touch sensor of claim 1, wherein the plurality of operation patterns is defined on a first layer and the plurality of sense patterns defined in a second layer different from the first layer.

3. The touch sensor of claim 1, wherein at least one of the plurality of operation patterns has a rectangular structure.

4. The touch sensor of claim 1, wherein the plurality of sense patterns extends along a first direction and the plurality of operation patterns extends along a second direction, so that each sense pattern overlaps two or more operation patterns and each operation patterns overlaps two or more sense patterns.

5. The touch sensor of claim 1, wherein the sense patterns have substantially the same width and the operation patterns have substantially the same width, the width of the operation patterns being wider than the width of the sense patterns.

6. The touch sensor of claim 1, wherein at least one of the plurality of operation patterns has a parallel structure in which the operation pattern is separated into two or more lines and the separated operation patterns are recombined once or more.

7. A touch sensor, comprising:
a plurality of operation patterns arranged in a first axis direction and supplied with a voltage;
a dielectric material layer formed over the plurality of operation patterns; and
a plurality of sense patterns formed over the dielectric material layer and arranged in a second axis direction to cross the first axis direction,
wherein at least one of the plurality of sense patterns has a parallel structure in which the sense pattern is separated into two or more lines and the separated sense patterns are recombined once or more.

8. The touch sensor of claim 7, further comprising a protection window formed over the plurality of sense patterns.

9. The touch sensor of claim 7, wherein the operation patterns and the sense patterns are made of a transparent conductive material.

10. The touch sensor of claim 7, wherein at least one of the plurality of operation patterns has a rectangular structure.

11. The touch sensor of claim 7, wherein at least one of the plurality of sense patterns has a parallel structure in which separation of the sense pattern into two or more lines and recombination of the separated sense patterns are repeated twice or more.

12. The touch sensor of claim 11, wherein the sense pattern is symmetrically separated into the two or more lines and the separated sense patterns are symmetrically recombined.

13. The touch sensor of claim 7, wherein at least one of the plurality of operation patterns has a parallel structure in which the operation pattern is separated into two or more lines and the separated operation patterns are recombined once or more.
